(19) United States
(12) Patent Application Publication
(10) Pub. No.: US 2026/0071959 A1
(43) Pub. Date: Mar. 12, 2026

(54) IMAGING-BASED NON-CONTACT GLOSS MEASUREMENT DEVICE AND METHOD

(71) Applicant: WeSpectra (Shanghai) Co., Ltd., Shanghai (CN)

(72) Inventors: Kangjun LIU, Shanghai (CN); Jing FENG, Shanghai (CN); Yaru WU, Shanghai (CN)

(73) Assignee: WeSpectra (Shanghai) Co., Ltd., Shanghai (CN)

(21) Appl. No.: 19/393,481

(22) Filed: Nov. 18, 2025

(30) Foreign Application Priority Data
Mar. 13, 2025 (CN) 202510302117.3

(51) Int. Cl. G01N 21/57; G01N 21/01; G01N 21/17; G01N 21/25

(52) U.S. Cl. CPC G01N 21/57; G01N 21/01; G01N 21/251; G01N 2021/177

(57) ABSTRACT

An imaging-based non-contact gloss measurement device, includes: a housing having a top cover provided with a measurement window, a measurement zone being located above the measurement window; an illumination light source mounted inside the housing and on one side of the measurement window and configured to illuminate the measurement zone at an incident angle θ₁; and a grayscale camera mounted inside the housing and on the other side of the measurement window and configured to receive light reflected from the measurement zone at a reflection angle θ₂ for grayscale imaging, and obtaining gloss values from the grayscale values. The illumination light source has an incident divergence angle

$${α}_{1}^{′}$$

in the measurement plane and an incident divergence angle

$${β}_{1}^{′}$$

perpendicular to the measurement plane; the grayscale camera has a reflection divergence angle

$${α}_{2}^{′}$$

in the measurement plane and a reflection divergence angle

$${β}_{2}^{′}$$

perpendicular to the measurement plane, θ₁=θ₂,

$${a}_{1}^{′} > {α}_{2}^{′} and {β}_{1}^{′} > {β}_{2}^{′} .$$

### CROSS-REFERENCE TO RELATED APPLICATIONS

This application claims priority to Chinese Patent Application No. 202510302117.3 with a filing date of Mar. 13, 2025. The content of the aforementioned application, including any intervening amendments thereto, is incorporated herein by reference.

### BACKGROUND OF THE INVENTION

### 1. Technical Field

The present application relates to the technical field of optical inspection and, in particular, to an imaging-based non-contact gloss measurement device.

### 2. Description of Related Art

Glossmeter, also called gloss tester, is a measurement device used for measuring the surface gloss of ceramics, paints, inks, plastics, marble, aluminum, electroplated parts, hardware and other materials.

Conventional gloss measurement devices measure the gloss of a sample based on the principle of light reflection. Specifically, the sample is illuminated under the conditions of a specified incident angle and a specified light beam to obtain a light beam in the direction of a specular reflection angle. Glossmeter usually comprises a light source, a lens, a receiver and a display module.

However, most gloss measurement devices available on the market for measuring the gloss of products are contact-type. For some special scenarios, contact-type measurement is not applicable as it may cause damage to products. Moreover, due to the limitation of the size of a measuring light spot, the measurement zone at least covers several square millimeters, making it impossible to measure the gloss of samples smaller than the size of the measurement zone.

In order to solve the above problems, the present application designs an imaging-based non-contact gloss measurement device and method.

### BRIEF SUMMARY OF THE INVENTION

In view of the shortcomings in the prior art, an object of the present application is to provide an imaging-based non-contact gloss measurement device and method, which can realize non-contact measurement of the gloss of a sample and also can be used for measuring the gloss of a small-sized sample.

A first aspect of the present application discloses an imaging-based non-contact gloss measurement device, including:
a housing, a top cover of which is provided with a measurement window, a measurement zone being located above the measurement window;
an illumination light source which is mounted inside the housing and on one side of the measurement window and is configured to illuminate the measurement zone at an incident angle θ₁; and
a grayscale camera which is mounted inside the housing and on the other side of the measurement window and is configured to receive light reflected from the measurement zone at a reflection angle θ₂ for grayscale imaging, measuring grayscale values, and obtaining gloss values from the grayscale values.

An optical axis of the illumination light source and an optical axis of the grayscale camera intersect at the center of the measurement zone, and the optical axis of the illumination light source and the optical axis of the grayscale camera together form a measurement plane; relative to the center of the measurement zone, the illumination light source has an incident divergence angle

$${α}_{1}^{′}$$

in the measurement plane and an incident divergence angle

$${β}_{1}^{′}$$

perpendicular to the measurement plane; relative to the center of the measurement zone, the grayscale camera has a reflection divergence angle

$${α}_{2}^{′}$$

in the measurement plane and a reflection divergence angle

$${β}_{2}^{′}$$

perpendicular to the measurement plane, where θ₁=θ₂,

$${α}_{1}^{′} > {α}_{2}^{′} , and {β}_{1}^{′} > {β}_{2}^{′} .$$

In the gloss measurement device of the present application, the measurement zone is located above the measurement window, thereby realizing non-contact measurement of a sample to be measured, avoiding contact between the surface of the sample to be measured and the measurement device, and preventing the surface of the sample to be measured from being damaged. In addition, during the imaging-based gloss measurement, the grayscale values of all pixels can be obtained from the grayscale camera. Therefore, the corresponding gloss of each pixel can be measured, and the gloss measurement of small-sized samples can be realized. Moreover, according to the technical solution of the present application, the incident divergence angle of the illumination light source is greater than the reflection divergence angle of the grayscale camera. On one hand, the illumination solid angle of the illumination light source is increased, thereby realizing gloss measurement over a larger area. On the other hand, the reflection divergence angle of the grayscale camera is reduced, and a photosensitive device with a smaller photosensitive area can be used for grayscale imaging, thereby reducing costs.

In the first aspect of the present application,

$${α}_{1}^{′} , {α}_{2}^{′} , {β}_{1}^{′} and {β}_{2}^{′}$$

are arranged such that a measurement optical path of the gloss measurement device is a reverse optical path that complies with the international standard ISO2813:2014. According to the reversible principle of an optical path, the gloss measurement device of the present application still meets the measurement requirements of the international standard ISO2813:2014, highly matches the international standard and has high measurement accuracy and consistency.

In the first aspect of the present application, the illumination light source is a uniform-light illumination system having a rectangular light outlet, and the size of the light outlet and a distance from the light outlet to the center of the measurement zone are set such that relative to the center of the measurement zone, the illumination light source has an incident divergence angle

$${α}_{1}^{′}$$

in the measurement plane and an incident divergence angle

$${β}_{1}^{′}$$

perpendicular to the measurement plane.

In the first aspect of the present application, the uniform-light illumination system is an integrating sphere light source.

In the first aspect of the present application, a light-emitting element of the uniform-light illumination system is any one of a xenon lamp, a halogen lamp, a white LED and a colored LED or a combination thereof.

The uniform-light illumination system provides uniform-light illumination throughout an illuminated area, thereby improving the accuracy of gloss measurement.

In the first aspect of the present application, the light-emitting element of the uniform-light illumination system is a white LED with a spectral power distribution complying with the international standard ISO2813:2014.

In the first aspect of the present application, the grayscale camera has a field stop, and the size of the field stop and a distance from the field stop to the center of the measurement zone are set such that relative to the center of the measurement zone, the grayscale camera has a reflection divergence angle

$${α}_{2}^{′}$$

in the measurement plane and a reflection divergence angle

$${β}_{2}^{′}$$

perpendicular to the measurement plane.

In the first aspect of the present application, the gloss measurement device further includes a filter which is disposed in the measurement optical path of the gloss measurement device and configured to adjust the spectral power distribution to comply with the international standard ISO2813:2014.

By using the light-emitting element with a spectral power distribution complying with international standards, or using a filter in the measurement optical path to adjust the spectral power distribution to meet international standards, the measurement device can comply with international standards, thereby improving the accuracy and consistency of gloss measurement.

In the first aspect of the present application, a monitoring plate is disposed on at least one side of the measurement window, at least a part of the monitoring plate is located within the capture zone of the grayscale camera, and the monitoring plate is configured to monitor and compensate the measured grayscale values. The monitoring plate can monitor the change of measured values caused by the fluctuation of the illumination light source in real time and perform real-time compensation, thereby improving the accuracy of gloss measurement.

In the first aspect of the present application, θ₁=θ₂=20°, or θ₁=θ₂=60°, or θ₁=θ₂=85°. The gloss measurement device of the present application can adjust the incident angle and the reflection angle, thereby realizing gloss measurement of samples of different glosses such as high gloss, medium gloss, low gloss.

A second aspect of the present application provides an imaging-based non-contact gloss measurement method, which uses the gloss measurement device described above to perform measurement. The method includes: selecting at least one target sub-zone in the measurement zone in control software, and calculating a mean gloss value of the target sub-zone using the grayscale value of each pixel in the target sub-zone.

In the second aspect of the present application, the gloss measurement method further includes monitoring and compensating the measured grayscale values using the monitoring plate.

The imaging-based non-contact gloss measurement device and method according to the present application can realize the gloss measurement of each pixel in a captured image. Moreover, the gloss measurement of the sample at multiple angles can be achieved by setting multiple illumination light sources and grayscale cameras.

### BRIEF DESCRIPTION OF THE SEVERAL VIEWS OF THE DRAWINGS

FIG. 1 is a schematic diagram of gloss measurement for different types of samples (with high gloss, medium gloss and low gloss) to be measured at different incident angles in accordance with the international standard ISO 2813:2014.

FIG. 2 is a structural schematic diagram of an embodiment of the gloss measurement device according to the present application.

FIG. 3 is a schematic diagram of the gloss measurement principle using a convergent optical path in accordance with international standards in the prior art.

FIG. 4 is a user interaction interface of control software for the gloss measurement device according to the present application.

### DETAILED DESCRIPTION OF THE INVENTION

The present application will be further described below in conjunction with specific embodiments and the accompanying drawings. It should be understood that the illustrative embodiments of the present disclosure are only for explaining the present application, not for limiting the present application. In addition, for the convenience of description, only the parts related to the present application rather than all structures or processes are shown in the accompanying drawings.

The implementation of the invention will be described below by way of specific embodiments. Those skilled in the art can easily understand other advantages and effects of the invention from the content disclosed herein. Although the description of the present application will be introduced in conjunction with preferred embodiments, this does not mean that the features of the invention are limited to the embodiments. On the contrary, the purpose of introducing the invention in conjunction with embodiments is to cover other options or modifications that may be extended based on the claims of the present application. In order to provide a deep understanding of the present application, the following description will contain many specific details. The present application may also be implemented without using these details. In addition, in order to avoid confusing or obscuring the key points of the present application, some specific details will be omitted in the description. It should be noted that the embodiments in the present application and the features in the embodiments may be combined with each other, provided that there is no conflict.

Unless the context otherwise specifies, the terms “comprise”, “have” and “include” are synonyms. The phrase “A/B” means “A or B”. The phrase “A and/or B” means “(A and B) or (A or B)”.

It should be understood that although terms such as “first” and “second” may be used herein to describe various components, units or data, these components, units or data should not be limited by these terms. These terms are only used to distinguish one feature from another. For example, without departing from the scope of the exemplary embodiments, a first feature may be referred to as a second feature, and similarly, a second feature may be referred to as a first feature.

It should be understood that although directional terms such as “upper”, “lower”, “left” and “right” may be used herein to describe the positional relationship between various components, these directional terms are only used to indicate the directions in the drawings for easy understanding, and cannot be used to limit the protection scope of the present application.

It should be noted that, as used herein, similar reference numerals and letters denote similar items in the accompanying drawings; therefore, once an item is defined in a drawing, it does not need to be further defined and explained in subsequent drawings.

In order to make the objects, technical solutions and advantages of the present application clearer, the implementation modes of the present application will be further described in detail below in conjunction with the accompanying drawings.

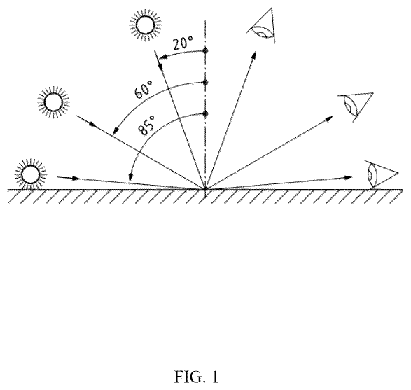

As shown in FIG. 1, in accordance with gloss measurement specified in the international standard ISO 2813:2014, the gloss measurement device measures the gloss of different types of samples (with high gloss, medium gloss and low gloss) to be measured by using an illumination light source with different incident angles. An incident angle of 20° is used for gloss measurement of a high-gloss sample, 60° for a medium-gloss sample, and 85° for a low-gloss sample.

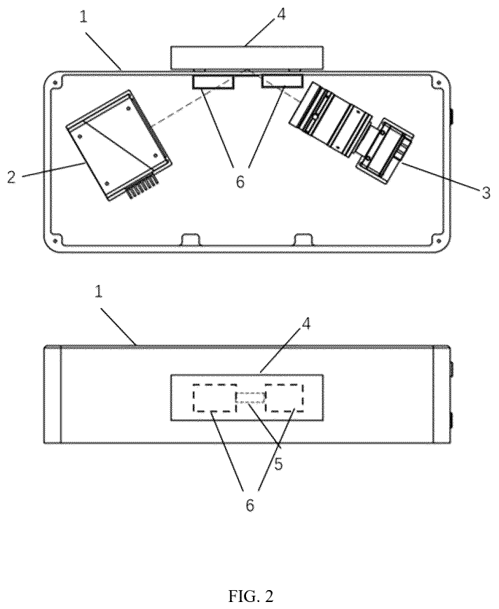

FIG. 2 is a structural schematic diagram of an embodiment of the gloss measurement device according to the present application. The upper diagram in FIG. 2 is a front view of the gloss measurement device with a front cover of the housing removed, and the lower diagram is a bottom view of the gloss measurement device.

As shown in FIG. 2, the gloss measurement device includes a housing 1, an illumination light source 2, and a grayscale camera 3. A sample placement zone for placing a sample 4 to be measured is disposed on an upper surface of the housing 1, and a top cover of the housing 1 is provided with a measurement window 5. A measurement zone (not shown) is located above the measurement window 5. An optical axis of the illumination light source 2 and an optical axis of the grayscale camera 3 intersect at the center of the measurement zone. Here, the measurement zone being located above the measurement window 5 means that the measurement zone can be understood as a planar area, and the plane where the measurement zone is located is above the measurement window 5 and parallel to the plane where the measurement window 5 is located, and the optical axis of the illumination light source 2 and the optical axis of the grayscale camera 3 intersect at the center of the measurement zone, so that non-contact measurement as described in detail below can be achieved. Although the measurement zone can be understood as a planar area, a person skilled in the art should easily understand that the grayscale camera 3 has a certain depth of field, so grayscale imaging can be clearly performed within the range of the depth of field of the grayscale camera 3.

The illumination light source 2 is mounted inside the housing 1 and on the left side of the measurement window 5 and is configured to illuminate the measurement zone at an incident angle θ₁ (not shown). Here, the incident angle θ₁ refers to the angle between the optical axis direction of the illumination light source 2 and the normal direction of the plane where the measurement window 5 is located.

The grayscale camera 3 is mounted inside the housing 1 and on the right side of the measurement window 5 and is configured to receive light reflected from the measurement zone at a reflection angle θ₂ (not shown) for grayscale imaging, measuring grayscale values, and obtaining gloss values from the grayscale values. Here, the reflection angle θ₂ refers to the angle between the optical axis direction of the grayscale camera 3 and the normal direction of the plane where the measurement window 5 is located, and as known from the principle of optical specular reflection, θ₁=θ₂.

What is provided by the present application is an imaging-based non-contact gloss measurement device. In the art, if the distance between the surface of a sample to be measured and the surface of a measurement device is 0, it is a contact measurement. If the distance between the surface of a sample to be measured and the surface of a measurement device is greater than 0, which means that the sample to be measured can leave the surface of the measurement device, it is a non-contact measurement. Since contact measurement may cause contamination on the surface of a sample to be measured during industrial production, non-contact measurement is more preferred. However, if a gloss measurement device adopts integrated measurement or works with a large non-contact measurement distance, use of non-contact measurement may suffer from deviations in gloss measurement results due to ambient light leaking into or contaminating the measurement zone. As shown in FIG. 2, the present application adopts an imaging-based non-contact technical solution. The optical axis of the illumination light source 2 and the optical axis of the grayscale camera 3 intersect at 0 to 10 mm, preferably 2 mm, above the measurement window 5, so that non-contact measurement can be achieved. The imaging-based non-contact gloss measurement device according to the present application will not affect the measured gloss of the sample even if the sample is too small to cover the entire measurement zone, resulting in the leakage of light source. Moreover, the technical solution of imaging-based gloss measurement is not limited by the spot size of a measuring beam, and can measure the gloss on sample surface areas much smaller than the spot size.

The gloss of the surface of the sample to be measured will directly affect the intensity of light reflected from the surface of the sample. When the gloss of the surface of a sample to be measured is high, it means that the surface of the sample has a strong ability to reflect specular light, and a higher grayscale value will be present on the image. This is because a high-gloss surface can more effectively reflect incident light into the camera or imaging device, creating brighter areas in the image. In contrast, a low-gloss surface has a weaker ability to reflect specular light, and the grayscale values in the image are relatively low.

In an ideal case, it can be assumed that there is a simple linear relationship between gloss value G and image grayscale value I, i.e., G=k×I, where k is a proportional coefficient. This coefficient k can be determined by calibrating a standard sample with a known gloss. For example, you can use a standard sample with a known gloss value, take an image of the standard sample and obtain the corresponding grayscale value, and then calculate the value of k through the above linear formula. Then, for other samples to be measured, you can use the value of k to convert the image grayscale value into a gloss value. However, in actual practice, due to factors such as the roughness and color of the surface of the sample and ambient light, the relationship between grayscale value and gloss may be non-linear.

In the present application, grayscale values are converted into gloss values according to the following calibration method. For instance, the incident angle and the reflection angle satisfy θ₁=θ₂=60°, there are at least three standard samples and the respective gloss values of these standard samples are known at the incident angle of 60°. For example, the three standard samples have high gloss, medium gloss and low gloss respectively. The incident angle θ₁ of the illumination light source 2 and the reflection angle θ₂ of the gray scale camera 3 of the gloss measurement device of the present application are set to 60° and the three standard samples are imaged respectively by the gloss measurement device to obtain corresponding grayscale values. For a 12-bit grayscale camera, its range of grayscale values is between 0 and 4095. As shown in Table 1 below: Standard sample 1 is a low-gloss sample with a known gloss value I of 12.4, and the standard sample 1 is imaged using the gloss measurement device to obtain grayscale value G which is 257.439. Standard sample 2 is a medium-gloss sample with a known gloss value I of 57.2, and the standard sample 2 is imaged using the gloss measurement device to obtain grayscale value G which is 1130.09. Standard sample 3 is a high-gloss sample with a known gloss value I of 97.7, and the standard sample 3 is imaged using the gloss measurement device to obtain grayscale value G which is 1990.32.

TABLE 1
Test results

| | Grayscale value G | Gloss value I |
|---|---|---|
| Standard sample 1 | 257.439 | 12.4 |
| Standard sample 2 | 1130.09 | 57.2 |
| Standard sample 3 | 1990.32 | 97.7 |

Using the above data, the grayscale value and the gloss value can form a mapping relationship through a fitting method, thus completing the calibration of the gloss measurement device. In addition, more data can be used to obtain a more accurate mapping relationship. For example, more standard samples can be used, such as four, five, six, or more standard samples. Here, the fitting method may include linear regression, polynomial regression, piecewise linear regression, spline interpolation, locally weighted regression. For instance, when the data shows a single linear trend, linear regression can be used for fitting to obtain a mapping relationship I=aG+b, where a is a proportional coefficient and b is a bias constant. When the data exhibits a non-linear but smooth changing trend (e.g., a quadratic or cubic curve), polynomial regression can be used for fitting to a mapping relationship I=a₀+a₁G+a₂G²+ . . . +aₙGⁿ, where aₙ represents an n-th order coefficient. When the data shows different linear trends in different intervals (e.g., different rates of change in low/high gloss regions), piecewise linear regression can be used, where the data is divided into multiple intervals and an independent linear model is fitted for each interval. If a continuous and smooth curve is required to avoid abrupt changes occurring in piecewise linear regression, spline interpolation can be used, which employs piecewise polynomials while maintaining smooth continuity at the nodes. When the data shows a complex nonlinear relationship, locally weighted regression can be used to perform local polynomial fitting on each data point, with weights decaying with distance.

In addition, the above calibration process of the gloss measurement device is described by way of an example where the incident angle and the reflection angle satisfy θ₁=θ₂=60°. It will be readily conceivable to those skilled in the art that the gloss measurement device can be correspondingly calibrated using the known gloss values of standard samples at an incident angle of 20° or 85°.

During the use of the gloss measurement device, the measured grayscale value G may change due to the aging of the measurement device. Therefore, during daily use, the gloss measurement device needs to be calibrated regularly at certain intervals, such as daily, every two days, or weekly. For calibration, a piece of black optical glass with high uniformity and high gloss is used as a high-gloss calibration plate, and the factory G-I value pair of the calibration plate is known. During calibration, the gloss measurement device is used to measure the high-gloss calibration plate to obtain a grayscale value G₁ Based on the factory gray value G₀ of the high-gloss calibration plate, a calibration coefficient can be calculated as K=G₀/G₁. Then, within the calibration period, every measured grayscale value needs to be multiplied by this calibration coefficient K to obtain a calibrated grayscale value.

Preferably, in addition to the high-gloss calibration plate, a medium-gloss calibration plate and a low-gloss calibration plate may also be used to calibrate the grayscale values measured by the measurement device.

During the calibration period, the measured grayscale value may also have measurement deviations due to factors such as fluctuation of the illumination light source, for example, the decrease in light intensity caused by thermal effects generated as temperature rises. In order to eliminate these measurement deviations, as shown in FIG. 2, monitoring plates 6 are also disposed on the left and right sides of the measurement window 5 in the gloss measurement device, and at least a part of each monitoring plate 6 is located within the capture zone of the grayscale camera 3 and can be captured by the grayscale camera 3 and measured for its grayscale value. The monitoring plates 6 are optical black glass with high uniformity and high gloss. At a time point when the above-mentioned regular calibration is carried out, while the calibration is carried out using the standard plate, the grayscale values G₀′ of the monitoring plates 6 at that time are also recorded. Then, within this calibration period, during each measurement or at fixed intervals (e.g., every 1 min, 5 min, or 10 min), the grayscale camera 3 measures the grayscale values of the monitoring plates 6 to obtain G₁′, and the measured grayscale value of the sample to be measured is compensated in real time using a linear coefficient K′=G₀′/G₁′. The monitoring plates 6 are disposed on the inner wall of the top cover of the housing 1 and located around the measurement window 5. It should be noted that the monitoring plate 6 shown in FIG. 2 is just an example where the thickness is exaggerated for easy understanding and recognition. In an actual measurement device, the optical axis of the illumination light source 2 and the optical axis of the grayscale camera 3 will not be blocked by the monitoring plate. In addition, in FIG. 2, two grayscale monitoring plates 6 are provided and respectively disposed on the left and right sides of the measurement window 5, but the present invention is not limited thereto. Two monitoring plates 6 can also be provided on the front and rear sides of the measurement window 5, or only one monitoring plate 6 can be provided on any one of the front, rear, left and right sides of the measurement window. As long as at least a part of the monitoring plate 6 is ensured to be located within the capture zone of the grayscale camera 3, the grayscale camera 3 can perform capture, and get at least that part of the monitoring plate 6, and then calculate the corresponding grayscale value for the compensation.

It is easy to understand that although the above-described processes of regular calibration and real-time monitoring are carried out using measured grayscale values, the present invention is not limited thereto, and the gloss value can also be obtained through the mapping relationship to calculate the corresponding linear coefficient, thereby completing regular calibration and real-time monitoring.

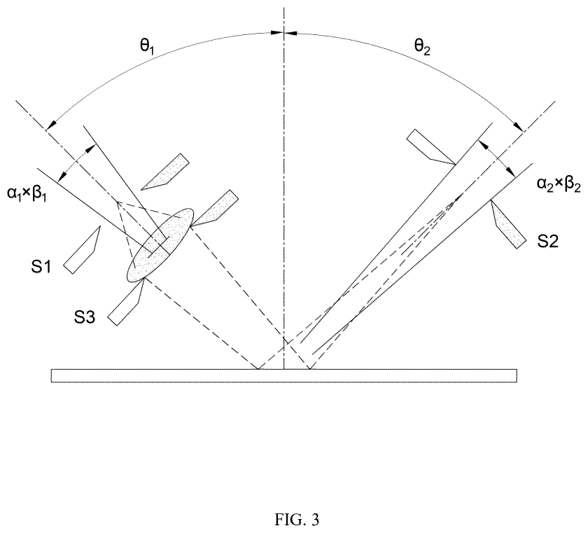

FIG. 3 is a schematic diagram of the gloss measurement principle using a convergent optical path in accordance with international standards in the prior art. In FIG. 3, θ₁ is an incident angle, θ₂ is a reflection angle, α₁ is an incident divergence angle in the measurement plane, α₂ is a reflection divergence angle in the measurement plane, β₁ is an incident divergence angle perpendicular to the measurement plane, β₂ is a reflection divergence angle perpendicular to the measurement plane, S₁ is an incident-side field stop, S₂ is a reflection-side field stop, and S₃ is a aperture stop. The measurement plane refers to the plane composed of the incident optical axis and the reflection optical axis.

Table 2 below shows the angle requirements for the incident divergence angles and the reflection divergence angles during the measurement of gloss at different incident angles in accordance with the international standard ISO2813:2014. It can be seen from Table 2 that the reflection divergence angles are greater than the incident divergence angles. Especially at the incident angle of 60°, the reflection incident angle angle β₂ perpendicular to the measurement plane is 11.7°±0.2°. Therefore, in the case of gloss measurement in accordance with this international standard, it is required to use a detection device with a large receiving area, resulting in high cost.

TABLE 2
Requirements on incident divergence angles and reflection divergence angles

| | | | | | Measurement |
|---|---|---|---|---|---|
| θ | α₁ | β₁ | α₂ | β₂ | object |
| 20° | 0.75° ± 0.1° | 2.5° ± 0.1° | 1.80° ± 0.05° | 3.6° ± 0.1° | High gloss |
| 60° | 0.75° ± 0.1° | 2.5° ± 0.1° | 4.4° ± 0.1° | 11.7° ± 0.2° | Medium gloss |
| 85° | 0.75° ± 0.1° | 2.5° ± 0.1° | 4.0° ± 0.3° | 6.0° ± 0.3° | Low gloss |

According to an embodiment of the gloss measurement device of the present application, the optical axis of the illumination light source and the optical axis of the grayscale camera together form a measurement plane; relative to the center of the measurement zone, the illumination light source 2 has an incident divergence angle

$${α}_{1}^{′}$$

in the measurement plane and an incident divergence angle

$${β}_{1}^{′}$$

perpendicular to the measurement plane; relative to the center of the measurement zone, the grayscale camera 3 has a reflection divergence angle

$${α}_{2}^{′}$$

in the measurement plane and a reflection divergence angle

$${β}_{2}^{′}$$

perpendicular to the measurement plane, where

$${α}_{1}^{′} > {α}_{2}^{′} , {β}_{1}^{′} > {β}_{2}^{′} .$$

According to the technical solution of the present application, the incident divergence angles are greater than the reflection divergence angles, which means that the illumination solid angle of the illumination light source 2 is increased, and gloss measurement in a larger area can be achieved. On the other hand, the field of view of the grayscale camera 3 can be small, which reduces the requirements for the field of view of the detection device and reduces costs. Moreover, according to the technical solution of the present application, a grayscale camera is used to perform grayscale imaging, and a corresponding gloss value is obtained using the grayscale value. In this way, within the range of the incident divergence angles of the illumination light source, the gloss value at the corresponding position of each pixel of the grayscale camera can be measured, which means that the gloss of a tiny area can be measured.

According to another embodiment of the present application,

$${α}_{1}^{′} , {α}_{2}^{′} , {β}_{1}^{′} and {β}_{2}^{′}$$

are arranged such that a measurement optical path of the gloss measurement device is a reverse optical path that complies with the international standard ISO2813:2014. Here, the reverse optical path that complies with the international standard ISO2813:2014 means that the optical path of the gloss measurement device of the present application is a reverse optical path of the optical path specified in the international standard ISO2813:2014. That is, as shown in Table 3,

$${α}_{1}^{′} = {α}_{2} , {α}_{2}^{′} = {α}_{1} , {β}_{1}^{′} = {β}_{2} and {β}_{2}^{′} = {β}_{1} .$$

According to the principle of an optical path being reversible, the gloss measurement device of the present application still meets the measurement requirements of the international standard ISO2813:2014, highly matches the international standard and has high gloss measurement accuracy and consistency.

TABLE 3
Requirements on incident divergence angles and reflection divergence
angles

| θ | ${a}_{1}^{′}$ | ${β}_{1}^{′}$ | ${a}_{2}^{′}$ | ${β}_{2}^{′}$ | Measurement object |
|---|---|---|---|---|---|
| 20° | 1.80° ± 0.05° | 3.6° ± 0.1º | 0.75° ± 0.1° | 2.5° ± 0.1° | High gloss |
| 60° | 4.4° ± 0.1° | 11.7° ± 0.2° | 0.75° ± 0.1° | 2.5° ± 0.1° | Medium gloss |
| 85° | 4.0° ± 0.3° | 6.0° ± 0.3° | 0.75° ± 0.1° | 2.5° ± 0.1° | Low gloss |

According to another embodiment of the present application, the illumination light source 2 of the gloss measurement device is a uniform-light illumination system having a rectangular light outlet, and the size of the light outlet and a distance from the light outlet to the measurement zone are set such that relative to the measurement zone, the illumination light source 2 has an incident divergence angle

$${α}_{1}^{′}$$

in the measurement plane and an incident divergence angle

$${β}_{1}^{′}$$

perpendicular to the measurement plane. The uniform-light illumination system can be realized by means of an integrating sphere, frosted glass, opalescent glass, Kohler illumination, fly-eye lens, or light guide fiber. The uniform-light illumination system is preferably an integrating sphere light source.

According to another embodiment of the present application, a light-emitting element of the uniform-light illumination system of the gloss measurement device is any one of a xenon lamp, a halogen lamp, a white LED and a colored LED or a combination thereof. Here, the colored LED refers to a monochromatic LED with a certain wavelength width, such as a green LED with a peak wavelength of 550 nm and a full width at half maximum of 20 nm. A required spectrum can be combined by multiple colored LEDs.

According to another embodiment of the present application, the light-emitting element of the uniform-light illumination system of the gloss measurement device is a white LED with a spectral power distribution complying with the international standard ISO2813:2014.

According to another embodiment of the present application, the grayscale camera 3 of the measurement device has a field stop, and the size of the field stop and a distance from the field stop to the center of the measurement zone are set such that relative to the center of the measurement zone, the grayscale camera 3 has a reflection divergence angle

$${α}_{2}^{′}$$

in the measurement plane and a reflection divergence angle

$${β}_{2}^{′}$$

perpendicular to the measurement plane.

According to another embodiment of the present application, the gloss measurement device further includes a filter which is disposed in the measurement optical path and configured to adjust the spectral power distribution to comply with the international standard ISO2813:2014. The filter being disposed in the measurement optical path means that the filter can be disposed at any position between the illumination light source 2 and the grayscale camera 3. Preferably, the filter can be disposed at the light outlet of the illumination light source 2 or at the lens of the grayscale camera 3.

The gloss measurement device provided in the present application is designed in accordance with the international standard ISO2813:2014, and the incident angle of the illumination light source 2 and the reflection angle of the grayscale camera 3 can be set to θ₁==θ₂=20°, or θ₁=θ₂=60°, or θ₁=θ₂=85°, so that the gloss measurement device can be used for measuring samples with different gloss.

The present application further provides an imaging-based non-contact gloss measurement method, which uses the gloss measurement device described above to perform measurement. The method includes: selecting at least one sub-zone in the measurement zone in the control software, and calculating a mean gloss value of the sub-zone using the grayscale value of each pixel in the target sub-zone.

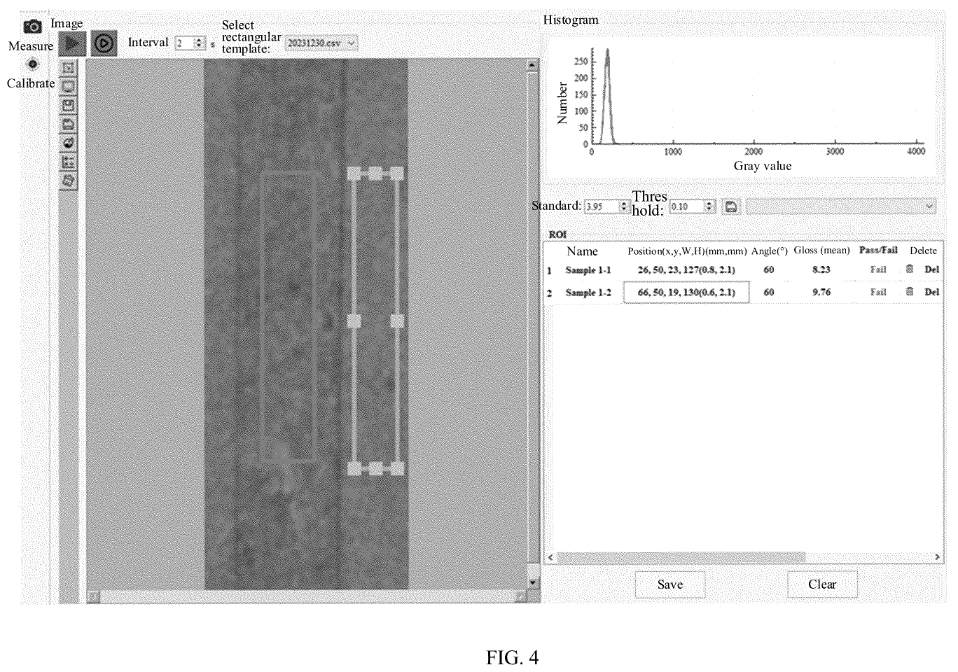

FIG. 4 is a user interaction interface of control software for the gloss measurement device according to the present application. The left part of FIG. 4 shows grayscale images obtained by capturing samples to be measured in the measurement zone using the gloss measurement device, where the middle dark gray part with irregular texture is the measurement zone. By means of the user interactive interface of the control software, multiple sub-zones can be selected within the measurement zone for gloss measurement respectively. The sub-zone may be rectangular, square, circular, elliptical, or any other closed shape. The right part of FIG. 4 shows the calculated gloss values. The control software obtains the grayscale value of each pixel in the sub-zone, averages the grayscale values of all pixels to obtain the mean grayscale value of the sub-zone, and then calculates the mean gloss value of the sub-zone based on the calibrated mapping relationship between the grayscale value and the gloss value described herein. You can also first calculate the gloss value of each pixel based on the calibrated mapping relationship, and then average the gloss values of all pixels in the sub-zone to obtain the mean gloss value of the sub-zone.

The above are only specific embodiments of the present application, but the scope of the present application is not limited thereto. Any person skilled in the art familiar with the technical field may conceive of changes or substitutions within the technical scope disclosed herein, and these changes or substitutions shall fall within the scope of the present application. Provided that there is no conflict, the embodiments of the present application and the features in the embodiments may be combined with each other. Therefore, the scope of the present application shall be subject to the scope of the claims.

What is claimed is:

1. An imaging-based non-contact gloss measurement device, comprising:
a housing, a top cover of which is provided with a measurement window, a measurement zone being located above the measurement window;
an illumination light source which is mounted inside the housing and on one side of the measurement window and is configured to illuminate the measurement zone at an incident angle θ₁; and
a grayscale camera which is mounted inside the housing and on another side of the measurement window and is configured to receive light reflected from the measurement zone at a reflection angle θ₂ for grayscale imaging, measuring grayscale values, and obtaining gloss values from the grayscale values; wherein
an optical axis of the illumination light source and an optical axis of the grayscale camera intersect at a center of the measurement zone, and the optical axis of the illumination light source and the optical axis of the grayscale camera together form a measurement plane; relative to the center of the measurement zone, the illumination light source has an incident divergence angle
$${α}_{1}^{′}$$
in the measurement plane and an incident divergence angle
$${β}_{1}^{′}$$
perpendicular to the measurement plane; relative to the center of the measurement zone, the grayscale camera has a reflection divergence angle
$${α}_{2}^{′}$$
in the measurement plane and a reflection divergence angle
$${β}_{2}^{′}$$
perpendicular to the measurement plane, where θ₁=θ₂,
$${α}_{1}^{′} > {α}_{2}^{′} , and {β}_{1}^{′} > {β}_{2}^{′} .$$

2. The gloss measurement device of claim 1, wherein
$${α}_{1}^{′} , {α}_{2}^{′} , {β}_{1}^{′} and {β}_{2}^{′}$$
are arranged such that a measurement optical path of the gloss measurement device is a reverse optical path that complies with the international standard ISO2813:2014.

3. The gloss measurement device of claim 1, wherein the illumination light source is a uniform-light illumination system having a rectangular light outlet, and a size of the light outlet and a distance from the light outlet to the center of the measurement zone are set such that relative to the center of the measurement zone, the illumination light source has an incident divergence angle
$${α}_{1}^{′}$$
in the measurement plane and an incident divergence angle
$${β}_{1}^{′}$$
perpendicular to the measurement plane.

4. The gloss measurement device of claim 3, wherein the uniform-light illumination system is an integrating sphere light source.

5. The gloss measurement device of claim 3, wherein a light-emitting element of the uniform-light illumination system is any one of a xenon lamp, a halogen lamp, a white light-emitting diode (LED) and a colored LED or a combination thereof.

6. The gloss measurement device of claim 3, wherein the light-emitting element of the uniform-light illumination system is a white LED with a spectral power distribution complying with the international standard ISO2813:2014.

7. The gloss measurement device of claim 1, wherein the grayscale camera has a field stop, and the size of the field stop and a distance from the field stop to the center of the measurement zone are set such that relative to the center of the measurement zone, the grayscale camera has a reflection divergence angle
$${α}_{2}^{′}$$
in the measurement plane and a reflection divergence angle
$${β}_{2}^{′}$$
perpendicular to the measurement plane.

8. The gloss measurement device of claim 1, further comprising a filter which is disposed in a measurement optical path of the gloss measurement device and configured to adjust spectral power distribution to comply with the international standard ISO2813:2014.

9. The gloss measurement device of claim 1, wherein a monitoring plate is disposed on at least one side of the measurement window, at least a part of the monitoring plate is located within a capture zone of the grayscale camera, and the monitoring plate is configured to monitor and compensate the measured grayscale values.

10. The gloss measurement device of claim 1, wherein θ₁=θ₂=20°, or θ₁=θ₂=60°, or θ₁=θ₂=85°.

11. An imaging-based non-contact gloss measurement method, which uses the gloss measurement device of claim 1 to perform measurement, wherein the method comprises: selecting at least one target sub-zone in the measurement zone in a control software, and calculating a mean gloss value of the at least one target sub-zone using the grayscale values of pixels in the target sub-zone.

12. The gloss measurement method of claim 11, further comprising: monitoring and compensating the measured grayscale values using a monitoring plate.
